(19) United States
(12) Patent Application Publication
(10) Pub. No.: US 2023/0211755 A1
(43) Pub. Date: Jul. 6, 2023

(54) CAPACITIVE/ACOUSTIC SENSOR LENSES FOR CLEANING FEEDBACK

(71) Applicant: GM Global Technology Operations LLC, Detroit, MI (US)

(72) Inventor: Brian Russell Wachter, Grosse Pointe Park, MI (US)

(21) Appl. No.: 17/569,787

(22) Filed: Jan. 6, 2022

(51) Int. Cl. B60S 1/56

(52) U.S. Cl. CPC B60S 1/56

(57) ABSTRACT

A vehicle, detection system of the vehicle and method of cleaning a surface of the vehicle is disclosed. The detection system includes a sensor, a cleaning system and a controller. The sensor is located at a surface of the detection system and is configured to detect a contaminant making contact with the surface and generate a signal. The cleaning system cleans the contaminant from the surface. The controller is configured to activate the cleaning system in response to the signal.

### INTRODUCTION

The subject disclosure relates to cleaning systems for a sensor surface and, in particular, to a system and method for identifying the presence of contaminants on the surface.

Some vehicles use sensors such as Lidar, infrared, time of flight, digital cameras, etc. for navigation and situational awareness. These sensors are generally protected from an outside environment of the vehicle by a transparent surface, which tends to accumulate debris such as rain, dirt, mud, dust, bugs, etc. Currently, debris is detected by the sensors themselves observing irregularities in the environment. However, it can be difficult to discern when an irregularity is due to vehicular motion, objects and/or environment around the sensor changing, or to contaminants on the surface. Accordingly, it is desirable to provide a system and method for reliably detecting a contaminant or debris on the surface of a sensor.

### SUMMARY

In one exemplary embodiment, a method of cleaning a surface of a vehicle is disclosed. A contaminant making contact with the surface is detected using a sensor coupled to the surface. A signal is generated at the sensor in response to the detection of the contaminant. A cleaning system is activated to clean the surface of the contaminant.

In addition to one or more of the features described herein, detecting the contaminant further comprises at least one of detecting a disruption in an electrical field in the surface generated by the contaminant making contact with the surface and detecting an acoustic signal generated by the contaminant making contact with the surface. The contaminant contacts a first side of the surface and the sensor is located at one of the first side of the surface and a second side of the surface. The cleaning system is activated until at least one of the signal is no longer being generated at the sensor and it is determined that the contaminant cannot be cleaned from the surface. In an embodiment, the signal indicates a location at which the contaminant contacts the surface, and the method further includes activating the cleaning system to clean the surface at the location. In an embodiment, a plurality of zones is defined over the surface, each zone having at least one sensor and an associated cleaning device, the method further including identifying a zone from the signal generated by the at least one sensor of the zone and activating the associated cleaning device for the zone. The surface can be a window or lens of a detection system of the vehicle.

In another exemplary embodiment, a detection system of a vehicle is disclosed. The detection system includes a sensor, a cleaning system and a controller. The sensor is located at a surface of the detection system and is configured to detect a contaminant making contact with the surface and generate a signal. The cleaning system cleans the contaminant from the surface. The controller is configured to activate the cleaning system in response to the signal.

In addition to one or more of the features described herein, the sensor is one of an electromagnetic sensor configured to detect a disruption in an electrical field in the surface generated by the contaminant making contact with the surface and an acoustic sensor configured to detect an acoustic signal generated by the contaminant making contact with the surface. The detection contaminant contacts a first side of the surface and the sensor is located at one of the first side of the surface and a second side of the surface. The controller is further configured to activate of the cleaning system until at least one of the signal is no longer being generated at the sensor and it is determined that the contaminant cannot be cleaned from the surface. The signal indicates a location at which the contaminant contacts the surface and the controller further configured to activate the cleaning system to clean the surface at the location. Wherein a plurality of zones is defined over the surface, each zone having at least one sensor and an associated cleaning device, the controller is further configured to identify a zone from the signal generated by the at least one sensor of the zone and activate the associated cleaning device for the zone. The surface can be a window or lens of the detections system.

In yet another exemplary embodiment, a vehicle is disclosed. The vehicle includes a sensor, a cleaning system and a controller. The sensor is located at a surface and is configured to detect a contaminant making contact with the surface and generate a signal. The cleaning system cleans the contaminant from the surface. The controller configured to activate the cleaning system in response to the signal.

In addition to one or more of the features described herein, the sensor is one of an electromagnetic sensor configured to detect a disruption in an electrical field in the surface generated by the contaminant making contact with the surface; and an acoustic sensor configured to detect an acoustic signal generated by the contaminant making contact with the surface. The contaminant contacts a first side of the surface and the sensor is located at one of the first side of the surface and a second side of the surface. The controller is further configured to activate of the cleaning system until at least one of the signal is no longer being generated at the sensor and it is determined that the contaminant cannot be cleaned from the surface. The signal indicates a location at which the contaminant contacts the surface and the controller is further configured to activate the cleaning system to clean the surface at the location. Wherein a plurality of zones is defined over the surface, each zone having at least one sensor and an associated cleaning device, the controller is further configured to identify a zone from the signal generated by the at least one sensor of the zone and activate the associated cleaning device for the zone.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle having a detection system;

FIG. 2 shows a schematic diagram of a cleaning system for cleaning the surface of the detection system;

FIG. 3 shows a front view of the surface in an alternate embodiment; and

FIG. 4 shows a flowchart of a method for cleaning the surface, in an embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

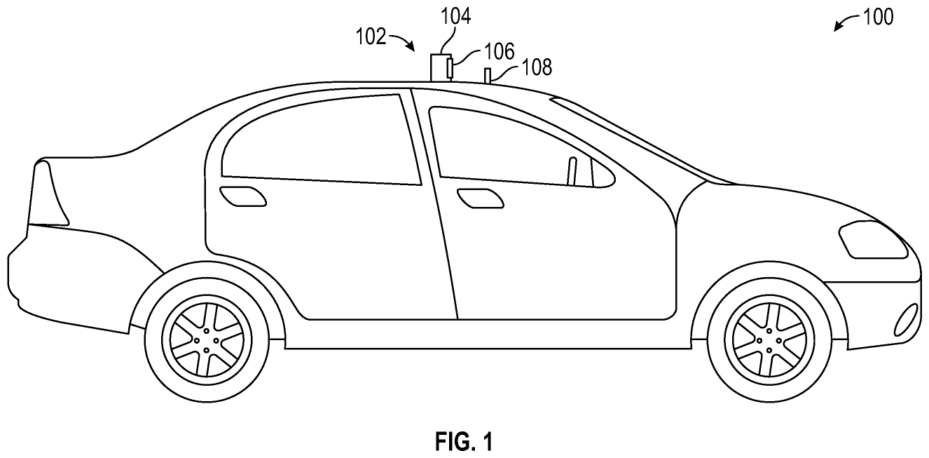

In accordance with an exemplary embodiment, FIG. 1 shows a vehicle 100 having a detection system 102. The detection system 102 can be a Lidar system, infrared system, time of flight system, optical sensor system, digital camera system or other system that operates within the electromagnetic spectrum. The detection system 102 includes a housing 104 and a window or surface 106. The housing 104 houses various electrical components of the detection system 102 to protect them from the environment, such as rain, dirt, dust, etc. The electrical components of the detection system 102 can include a light source, such as a laser, a light-sensitive sensor, a camera, a charged-coupled device, or other suitable sensor equipment. The surface 106 is transparent or semi-transparent in a region of the electromagnetic spectrum surrounding an operating wavelength of the detection system 120, thereby allowing a light beam or other electromagnetic radiation to pass through the surface 106. The vehicle 100 also includes a cleaning system 108 that cleans contaminants or debris, such as rain, dirt, mud, insects, etc. from the surface 106.

In various aspects, the surface 106 can be a lens of the detection system 102. In other embodiments, the surface 106 can be any surface of the vehicle 100 that may require cleaning, such as a windshield of the vehicle or a side window.

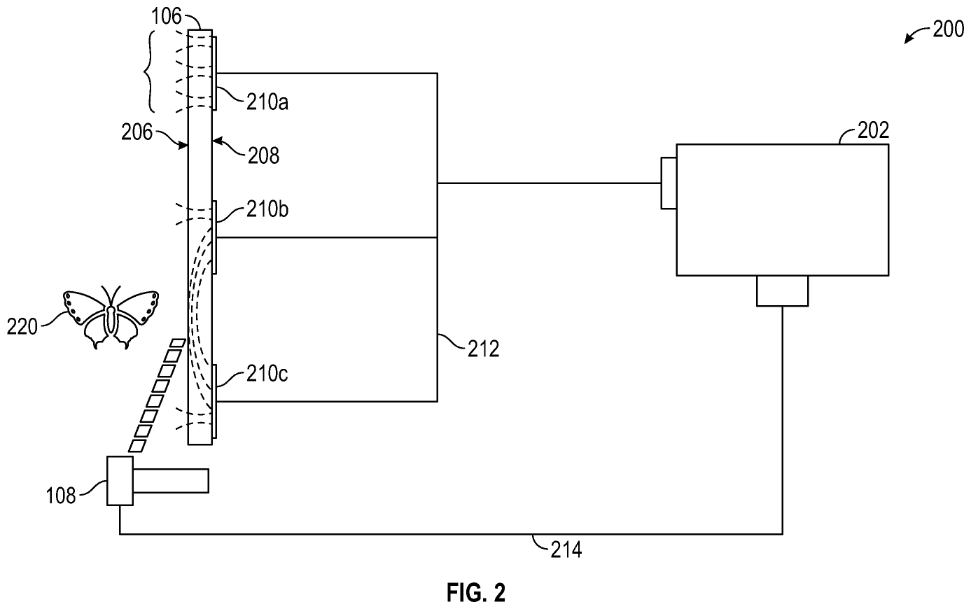

FIG. 2 shows a schematic diagram of a system 200 for cleaning the surface 106 of the vehicle. The system 200 includes the surface 106, a controller 202, and the cleaning system 108. The cleaning system 108 can be a nozzle, a wiper or other suitable device for removing a contaminant 220 from the surface. The surface 106 has a first side 206 that is exposed to the environment of the vehicle 100 and a second side 208 fully or partially shielded from the environment. In general, the surface 106 is a planar surface and the first side 206 is opposite the second side 208. A grid or array of sensors 210a-210c can be located at either the first side 206 or the second side 208. In various embodiments, the array of sensors 210a-210c partially or fully covers a selected side of the surface 106. The array of sensors 210a-210c can be included in a transparent conductive film that adheres to either the first side 206 or the second side 208. Each sensor of the array of sensors 210a-210c is communicatively coupled to the controller 202. In various embodiments, a signal pathway 212 extends between the array of sensors 210a-210c and the controller 202 through which a detection signal can be communicated. A cleaning system provides a signal pathway 214 by which the controller 202 can control operation of the cleaning system 108.

A selected sensor of the array of sensors 210a-210c can be an electromagnetic sensor or an acoustic sensor. An electromagnetic sensor can detect the contaminant 220 by generating an electrical field in the surface 106. When the contaminant 220 lands on the first side 206 of the surface 106, the electrical field is disrupted. The disruption in the electrical field is sensed by the electromagnetic sensor, which transmits the detection signal to the controller 202. An acoustic sensor can detect an acoustic signal or pressure wave caused by the containment impacting the first side 206. Upon detecting the acoustic signal or pressure wave, the acoustic sensor sends a detection signal to the controller 202.

The controller 202 includes a processor that accesses various programs that respond to the detection signal by activating the cleaning system 108. The controller 202 can determine which sensor (e.g., sensor 210b) sent the signal and therefore the location at the surface at which the contaminant 220 landed. The controller 202 can then activate the cleaning system to clean the contaminant 220 from the surface 106. In various embodiments, the cleaning system 108 can be activated to clean the system until the contaminant 220 is cleared from the surface 106. The cleaning system 108 can be activated for a set time interval, after which the controller 202 can check to see if the contaminant 220 has been cleared based on the absence or presence of the detection signal. If the contaminant 220 has not been cleared, the cleaning system 108 can be activated again. This process can be repeated until either the contaminant 220 is cleared or it is determined by the controller 202 that the contaminant cannot be cleared using the cleaning system. The cleanliness of the surface can be determined when the electromagnetic field or acoustic field returns to normal, thereby resulting in the detection signal no longer being sent to the controller 202.

In various embodiments, the controller 202 can determine which sensor sent the signal to the controller 202 and thereby determine the location of the contaminant 220. The cleaning system can then be activated to focus its cleaning at the location of the contaminant 220.

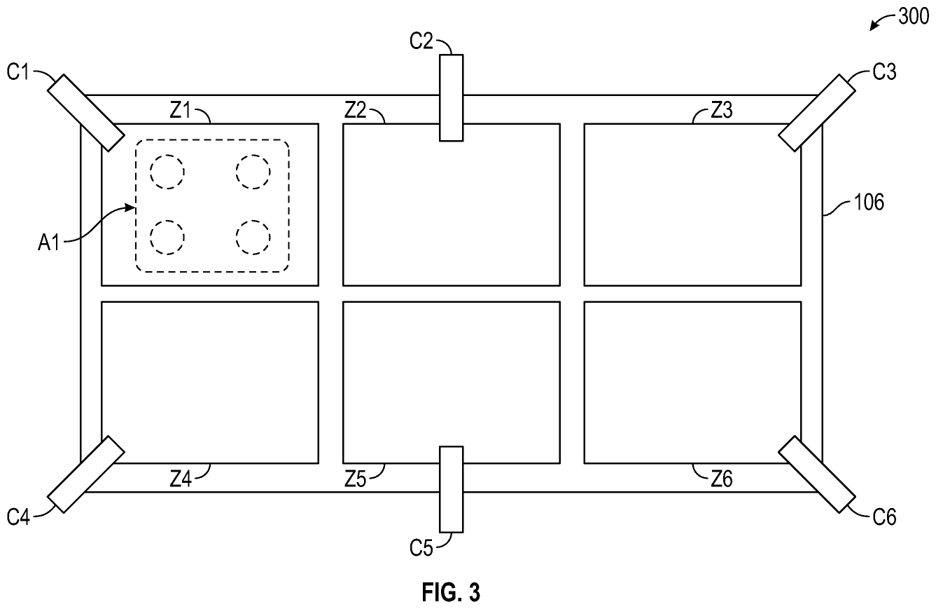

FIG. 3 shows a front view 300 of the surface 106 in an alternate embodiment. The surface 106 is subdivided into zones. For illustrative purposes, six zones (Z1, . . . , Z6) are shown. However, it is to be understood that any number, size, or shape of zones can be used at the surface 106 in various embodiments. All zones have at least one sensor therein. For illustrative purposes, at least one sensor (e.g., sensor group A1) is shown for the first zone Z1. It is to be understood however that any number, size, or shape of sensors can be used in any given zone, in various embodiments.

The cleaning system 108 includes a plurality of cleaning devices C1-C6, each cleaning device assigned to a zone Z1-Z6. While six cleaning devices (C1, . . . , C6) are shown for illustrative purposes, it is to be understood that any number, size, or shape of cleaning devices can be used at the surface 106 in various embodiments When a sensor within a given zone (e.g., zone Z1) sends a signal to the controller 202 indicating the presence of a contaminant 220 in the zone, the controller 202 can activate the associated cleaning device (e.g., cleaning device C1), without having to activate any of the other cleaning devices. In an alternate embodiment, any cleaning device can be aimed at a specific location of contamination.

By detecting contaminants using the methods disclosed herein, the detection system 102 can focus its effects on detecting changes in the environment. Any given zone can also detect a break, rupture, or fissure in the sensor surface. Such ruptures can be due, for example to high impact with an object, manufacturing defects, etc. The electrical field within the surface is broken by the break, causing the sensor to generate a detection signal, the characteristic of which can be detected by the controller 202 to the determine the need to replace the surface.

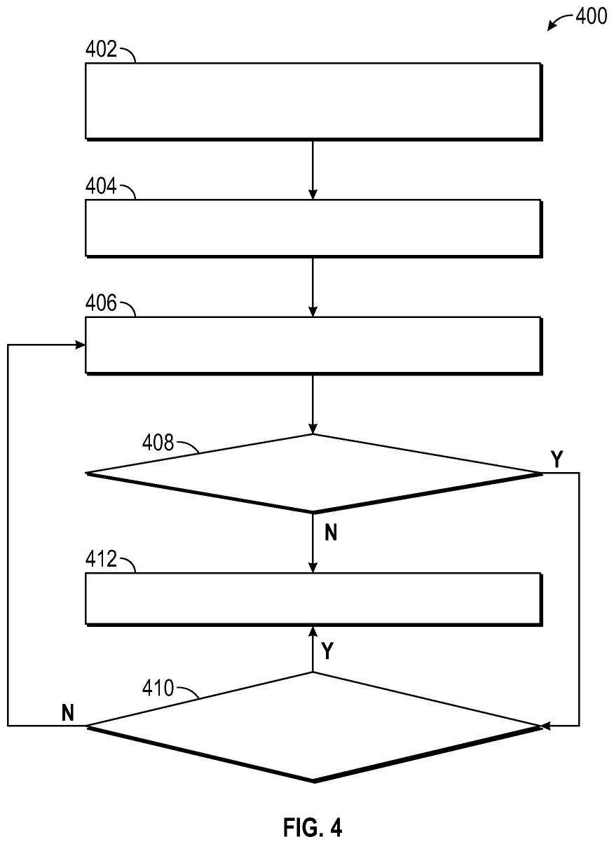

FIG. 4 shows a flowchart 400 of a method for cleaning the surface, in an embodiment. In box 402, a disruption is detected at the surface due to a contaminant being in contact with the surface. In box 404, a detection signal is generated in response to the disruption. In box 406, the cleaning system is activated for a selected time period to clean the contaminant from the surface. In box 408 the controller checks to see if the detection signal is still present (i.e., the contaminant is still at the surface). If the detection signal is still present the method proceeds to box 410. At box 410, the number of cleaning attempts made is compared to an attempt threshold. If the number of times that the cleaning system has been activated to clean off the contaminant is greater than the attempt threshold, the method proceeds to box 412, at which the cleaning system is deactivated. If the number of times that the cleaning system has been activated is less than or equal to the threshold, the method returns to box 406 for additional cleaning attempts.

In various embodiments, box 410 can include a time threshold and a duration of the cleaning activity can be compared to the time threshold. Thus, the cleaning activity is continued until a selected amount of time has passed. In this embodiment, upon returning to box 406, the cleaning system can either be reactivated or remain in an activated state.

Returning to box 408, if the detection signal is no longer present, the method proceeds to box 412, at which the cleaning system is deactivated.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of cleaning a surface of a vehicle, comprising:
detecting a contaminant making contact with the surface using a sensor coupled to the surface;
generating a signal at the sensor in response to the detection of the contaminant; and
activating a cleaning system to clean the surface of the contaminant.

2. The method of claim 1, wherein detecting the contaminant further comprises at least one of: (i) detecting a disruption in an electrical field in the surface generated by the contaminant making contact with the surface; and (ii) detecting an acoustic signal generated by the contaminant making contact with the surface.

3. The method of claim 1, wherein the contaminant contacts a first side of the surface and the sensor is located at one of: (i) the first side of the surface; and (ii) a second side of the surface.

4. The method of claim 3, wherein the cleaning system is activated until at least one of: (i) the signal is no longer being generated at the sensor; and (ii) it is determined that the contaminant cannot be cleaned from the surface.

5. The method of claim 1, wherein the signal indicates a location at which the contaminant contacts the surface, further comprising activating the cleaning system to clean the surface at the location.

6. The method of claim 1, wherein a plurality of zones is defined over the surface, each zone having at least one sensor and an associated cleaning device, further comprising identifying a zone from the signal generated by the at least one sensor of the zone, and activating the associated cleaning device for the zone.

7. The method of claim 1, wherein the surface is a window or lens of a detection system of the vehicle.

8. A detection system of a vehicle, comprising:
a sensor located at a surface of the detection system, the sensor configured to detect a contaminant making contact with the surface and generate a signal;
a cleaning system for cleaning the contaminant from the surface; and
a controller configured to activate the cleaning system in response to the signal.

9. The detection system of claim 8, wherein the sensor is one of: (i) an electromagnetic sensor configured to detect a disruption in an electrical field in the surface generated by the contaminant making contact with the surface; and (ii) an acoustic sensor configured to detect an acoustic signal generated by the contaminant making contact with the surface.

10. The detection system of claim 8, wherein the contaminant contacts a first side of the surface and the sensor is located at one of: (i) the first side of the surface; and (ii) a second side of the surface.

11. The detection system of claim 10, wherein the controller is further configured to activate of the cleaning system until at least one of: (i) the signal is no longer being generated at the sensor; and (ii) it is determined that the contaminant cannot be cleaned from the surface.

12. The detection system of claim 8, wherein the signal indicates a location at which the contaminant contacts the surface, the controller further configured to activate the cleaning system to clean the surface at the location.

13. The detection system of claim 8, wherein a plurality of zones is defined over the surface, each zone having at least one sensor and an associated cleaning device, the controller further configured to identify a zone from the signal generated by the at least one sensor of the zone and activate the associated cleaning device for the zone.

14. The detection system of claim 8, wherein the surface is a window or lens of the detections system.

15. A vehicle, comprising:
a sensor located at a surface, the sensor configured to detect a contaminant making contact with the surface and generate a signal;
a cleaning system for cleaning the contaminant from the surface; and
a controller configured to activate the cleaning system in response to the signal.

16. The vehicle of claim 15, wherein the sensor is one of: (i) an electromagnetic sensor configured to detect a disruption in an electrical field in the surface generated by the contaminant making contact with the surface; and (ii) an acoustic sensor configured to detect an acoustic signal generated by the contaminant making contact with the surface.

17. The vehicle of claim 15, wherein the contaminant contacts a first side of the surface and the sensor is located at one of: (i) the first side of the surface; and
(ii) a second side of the surface.

18. The vehicle of claim 17, wherein the controller is further configured to activate of the cleaning system until at least one of: (i) the signal is no longer being generated at the sensor; and (ii) it is determined that the contaminant cannot be cleaned from the surface.

19. The vehicle of claim 15, wherein the signal indicates a location at which the contaminant contacts the surface, the controller further configured to activate the cleaning system to clean the surface at the location.

20. The vehicle of claim 15, wherein a plurality of zones is defined over the surface, each zone having at least one sensor and an associated cleaning device, the controller further configured to identify a zone from the signal generated by the at least one sensor of the zone and activate the associated cleaning device for the zone.
